(19) United States
(12) Patent Application Publication
(10) Pub. No.: US 2015/0364228 A1
(43) Pub. Date: Dec. 17, 2015

(54) TRANSPARENT CONDUCTIVE FILMS AND COMPOSITIONS

(71) Applicant: Carestream Health, Inc., Rochester, NY (US)

(72) Inventors: Chaofeng Zou, Maplewood, MN (US); Haiyun Lu, Woodbury, MN (US); Erin R. Joiner, Woodbury, MN (US)

(21) Appl. No.: 14/711,079

(22) Filed: May 13, 2015

Related U.S. Application Data
(60) Provisional application No. 62/011,212, filed on Jun. 12, 2014.

(51) Int. Cl. H01B 1/22

(52) U.S. Cl. CPC H01B 1/22

(57) ABSTRACT

A conductive article comprising conductive structures dispersed within at least one binder, where the at least one binder comprises vinyl butyral repeat units and vinyl alcohol repeat units. Such conductive structures may, in some embodiments, comprise metal conductive structures, such as, for example, metal nanostructures. Silver nanowires are exemplary metal nanostructures.

### CROSS REFERENCE TO RELATED APPLICATIONS

This application claims the benefit of U.S. Provisional Application No. 62/011,212, filed Jun. 12, 2014, entitled “TRANSPARENT CONDUCTIVE FILMS AND COMPOSITIONS,” which is hereby incorporated by reference in its entirety.

### BACKGROUND

U.S. Patent Application Publication No. 2010/0330358 to Hashimoto discloses carbon nanotubes dispersed in a polymer binder. U.S. Pat. No. 8,338,699 to Smith et al. discloses a solar cell assembly encapsulated by a polymer that is at least partially in contact with an oxidizable metal component.

### SUMMARY

In some embodiments, a conductive article comprises conductive structures dispersed within at least one binder in which the at least one binder comprises vinyl butyral repeat units and vinyl alcohol repeat units. In some embodiments, the conductive structures comprise metallic structures. In some embodiments, the conductive structures comprise metallic nanostructures. In some embodiments, the conductive structures comprise metallic nanowires. In some embodiments, the conductive structures comprise silver nanowires.

### DESCRIPTION

All publications, patents, and patent documents referred to in this document are incorporated by reference herein in their entirety, as though individually incorporated by reference.

U.S. Provisional Application No. 62/011,212, filed Jun. 12, 2014, entitled “TRANSPARENT CONDUCTIVE FILMS AND COMPOSITIONS,” is hereby incorporated by reference in its entirety.

Transparent conductive films based on silver nanowire percolation network has become an important and promising technology for replacing indium tin oxide (ITO) based transparent conductive film. Silver nanowires when embedded in a thin film of polymer matrix and coated on a flexible plastic substrate, such as polyethylene terephthalate (PET) or polycarbonate (PC), provide a flexible transparent conductive film with the advantage of high conductivity, excellent optical property, and flexibility to allow repeat bending of such film without degradation of its electric and optical properties.

Various polymer materials can be used as binders for silver nanowire based conductive film. The relationship between a polymer and its performance when embedded with nanowires has been unpredictable. It is unclear which property or properties of a polymer binder affect the performance of a transparent conductive film. For reasons not quite understood, some polymer binders seem to have great impact on the electric property of resulting transparent conductive film. It is not unusual to test many different types of polymers before finding a suitable one to achieve high conductivity with low nanowire lay down, since high loading of nanowires would produce the conductive film with higher haze, hence deteriorating the optical property of such conductive films.

Polymer binders can also play an important role in controlling silver nanowire coating solution rheology, which is critical for gravure coating. By controlling the coating solution viscosity to optimize gravure printing process, and is important in slot coating, slide coating, and other extrusion coating processes to achieve optimum coating quality.

During the course of our research to identify the best polymer binders to achieve high surface conductivity, low haze, and excellent coating quality, we have found that high molecular weight polyvinyl butyrals with low hydroxyl group content showed unexpected performance to give higher conductivity, low haze, and low coating mottle.

### Conductive Structures

In some embodiments, transparent conductive films comprise conductive structures, which are materials that are electrically conductive. In particularly useful embodiments, such conductive structures may comprise conductive nanostructures. Nanostructures are structures having at least one “nanoscale” dimension less than 300 nm, and at least one other dimension being much larger than the nanoscale dimension, such as, for example, at least about 10 or at least about 100 or at least about 200 or at least about 1000 times larger. Examples of such nanostructures are nanorods, nanowires, nanotubes, nanopyramids, nanoprisms, nanoplates, and the like. “One-dimensional” nanostructures have one dimension that is much larger than the other two dimensions, such as, for example, at least about 10 or at least about 100 or at least about 200 or at least about 1000 times larger.

Such one-dimensional nanostructures may, in some cases, comprise nanowires. Nanowires are one-dimensional nanostructures in which the two short dimensions (the thickness dimensions) are less than 300 nm, preferably less than 100 nm, while the third dimension (the length dimension) is greater than 1 micron, preferably greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are preferred in some such applications.

### Polymer Binders

For a practical manufacturing process for transparent conductive films, it is important to have both the conductive components, such as silver nanowires, and a polymer binder in a coating solution. The polymer binder solution serves a dual role, as dispersant to facilitate the dispersion of silver nanowires and as a viscosifier to stabilize the silver nanowire coating dispersion so that the sedimentation of silver nanowires does not occur at any point during the coating process. It is also desirable to have the silver nanowires and the polymer binder in a single coating dispersion. This simplifies the coating process and allows for a one-pass coating, and avoids the method of first coating bare silver nanowires to form a weak and fragile film that is subsequently over-coated with a polymer to form the transparent conductive film.

In order for a transparent conductive film to be useful in various device applications, it is also important for the polymer binder of the transparent conductive film to be optically transparent and flexible, yet have high mechanical strength, good hardness, high thermal stability, and light stability. This requires polymer binders to be used for transparent conductive film to have Tg (glass transition temperature) greater than the use temperature of the transparent conductive film.

It may be desirable that a polymer binder possess the property of good film forming and ability to disperse silver nanowires in either aqueous or organic solvents. It may also be desirable that these polymer binders have excellent heat and light stability, and good adhesion to the plastic substrates. In some embodiments, the use of polymer binders containing nitrogen, oxygen, or other metal coordination atoms may be desirable as they suitably disperse and stabilize nanowires. Oxygen-containing groups, such as hydroxyl groups and carboxylate groups, have a strong affinity for binding to the silver nanowire surface and facilitate the dispersion and stabilization. Many oxygen-rich polymers also have good solubility in the polar organic solvents commonly used to prepare organic solvent-coated materials, while other oxygen-rich polymers have good solubility in water or the aqueous solvent mixtures commonly used to prepare aqueous solvent-coated materials. Non-limiting examples of polymer binders having suitable dispersing and stabilizing abilities include cellulose polymers, polyurethanes, polyacrylics, polyvinyl alcohols, and polyvinyl butyrals.

The transparent conductive articles comprising silver nanowires and water soluble polymer binders also show excellent clarity, high scratch resistance, and hardness. In addition, transparent conductive films prepared using these polymer binders have good adhesion to supports comprising polyethylene terephthalate (PET), poly(methylmethacrylate), polycarbonate, and the like, when an appropriate subbing layer is applied between the support and the conductive layer.

If desired, scratch resistance and hardness of the transparent conductive films with these polymer binders to the support can be improved by use of crosslinking agents to crosslink the polymer binders. Isocyanates, alkoxyl silanes, and melamines are examples of typical crosslinking agents for cellulose ester polymers containing free hydroxyl groups. Vinyl sulfones and aldehydes are examples of typical crosslinking agents for gelatin binders.

### Binders

In exemplary embodiments, the polymer binder may comprise one or more polyvinyl acetals. Polyvinyl acetal is the generic name for the class of polymers formed by the reaction of polyvinyl alcohol with one or more aldehydes. Polyvinyl acetal is also the name for the specific member of this class formed by reaction of polyvinyl alcohol and acetaldehyde. Typically, the aldehyde is formaldehyde or an aliphatic aldehyde having 2 to 4 carbon atoms. Acetaldehyde and butyraldehyde are commonly used aldehydes and form polyvinyl acetal (the specific polymer) and polyvinyl butyral respectively. In one exemplary embodiment, the polyvinyl acetal is polyvinyl butyral, polyvinyl acetal, or mixtures thereof.

In some embodiments, the polyvinyl acetal binder may comprise a polyvinyl butyral resin, such as shown below.

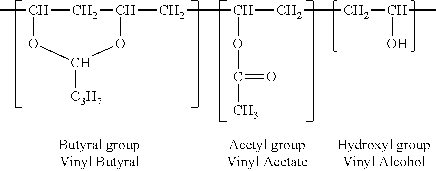

Such a binder may be prepared by a reaction of one or more polyvinyl alcohol hydroxyl groups and an aldehyde, such as butyraldehyde. In general, a polymer containing vinyl alcohol repeat units may also contain vinyl acetate repeat units, since the vinyl alcohol repeat units are generally formed from at least some of the vinyl acetate repeat units in the polymer by, for example, hydrolysis. The reaction of the hydroxyl groups with the aldehyde may be represented as:

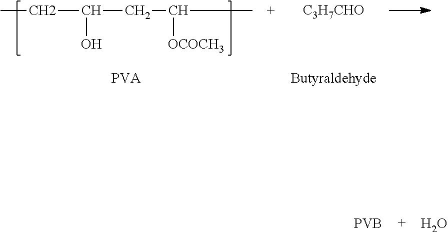

where PVA represents polyvinyl alcohol and PVB represents the resulting polyvinyl butyral resin.

Since the complete reaction of polymeric hydroxyl groups with the aldehyde may not take place, the product polymer may also comprise vinyl alcohol and vinyl acetate repeat units in addition to the vinyl butyral repeat units, as shown above. In some embodiments, the binder may comprise at least one butyral group, at least one acetyl group, and optionally, at least one hydroxyl group. In some embodiments, the binder may be a terpolymer of monomers comprising vinyl butyral, vinyl alcohol, and optionally, vinyl acetate. In some embodiments, binders may comprise copolymers of at least one first repeat unit comprising repeat units derived from at least one vinyl alcohol, at least one second repeat unit comprising repeat units derived from at least one butyraldehyde, and optionally at least one third repeat unit comprising repeat units derived from at least one vinyl acetate.

The characteristics and properties of polyvinyl butyral by itself or in a mixture to form the silver layer comprising a photosensitive catalyst may affect the electrical and optical property of a silver nanowire transparent conductive film. These properties include, but are not limited to, molecular weight and hydroxyl content. These properties may be interrelated in their effect on resistivity and/or haze of the transparent conductive film. These differences in these properties and their effect on the electrical and optical properties of the resultant transparent conductive film were examined.

### EXEMPLARY EMBODIMENTS

U.S. Provisional Application No. 62/011,212, filed Jun. 12, 2014, entitled “TRANSPARENT CONDUCTIVE FILMS AND COMPOSITIONS,” which is hereby incorporated by reference in its entirety, disclosed the following four (4) non-limiting exemplary embodiments:

A. A conductive article comprising:

conductive structures dispersed within at least one binder,

wherein the at least one binder comprises vinyl butyral repeat units and vinyl alcohol repeat units.

B. The conductive article of embodiment A, wherein conductive structures comprise metallic structures.
C. The conductive article of embodiment A, wherein conductive structures comprise metallic nanowires.
D. The conductive article of embodiment A, wherein conductive structures comprise silver nanowires.

### EXAMPLES

### Materials and Methods

All materials used in the following examples (e.g. methanol, 2-propanol) are readily available from standard commercial sources, such as Sigma-Aldrich Co. LLC (St. Louis, Mo.), unless otherwise specified. The following additional methods and materials were used.

BM-5 is a polyvinyl butyral resin having a hydroxyl content of about 34% and molecular weight of about 5.3×10⁴ grams per mole. BM-5 is available from Sekisui Chemical Co., Ltd. under the trade name S-LEC™ BM-5.

BH-9Z is a polyvinyl butyral resin having a hydroxyl content of about 34% and molecular weight of about 22.0×10⁴ grams per mole. BH-9Z is available from Sekisui Chemical Co., Ltd. under the trade name S-LEC™ BH-9Z.

B-72 is a polyvinyl butyral resin having a hydroxyl content of about 18.5% and molecular weight of about 20.0×10⁴ grams per mole. B-72 is available from Eastman Chemical Co. under the trade name BUTVAR® B-72.

B-74 is a polyvinyl butyral resin having a hydroxyl content of about 17.5-20.0% and molecular weight of about 120,000-150,000 grams per mole. B-74 is available from Eastman Chemical Co. under the trade name BUTVAR® B-74.

B-76 is a polyvinyl butyral resin having a hydroxyl content of about 11.5-13.5% and molecular weight of about 90,000-120,000 grams per mole. B-76 is available from Eastman Chemical Co. under the trade name BUTVAR® B-76.

B30T is a polyvinyl butyral resin having a hydroxyl content of about 35.7 mole % and number average molecular weight of about 3.5×10⁴ grams per mole. B30T is available from Kuraray Europe GmbH, BU PVB under the trade name MOWITAL® PIOLOFORM® B 30 T PVB.

B60H is a polyvinyl butyral resin having a hydroxyl content of about 28.2 mole % and number average molecular weight of about 5.5×10⁴ grams per mole. B60H is available from Kuraray Europe GmbH, BU PVB under the trade name MOWITAL® PIOLOFORM® B 60 H PVB.

B60HH is a polyvinyl butyral resin having a hydroxyl content of about 20.9 mole % and number average molecular weight of about 5.5×10⁴ grams per mole. B60HH is available from Kuraray Europe GmbH, BU PVB under the trade name MOWITAL® PIOLOFORM® B 60 HH PVB.

B60T is a polyvinyl butyral resin having a hydroxyl content of about 35.7 mole % and number average molecular weight of about 5.5×10⁴ grams per mole. B60T is available from Kuraray Europe GmbH, BU PVB under the trade name MOWITAL® PIOLOFORM® B 60 T PVB.

B75H is a polyvinyl butyral resin having a hydroxyl content of about 18-21% and molecular weight of about 100,000 grams per mole. B75H is available from Kuraray Europe GmbH, BU PVB under the trade name MOWITAL® PIOLOFORM® B75H PVB.

NUOSPERSE® FA196 liquid pigment dispersing agent is available from Elementis Specialties, Hightstown, N.J.

### Methods

### Preparation of Silver Nanowires

Four different sets of silver nanowires having different ranges of diameters and lengths were used in the Examples.

The first set of silver nanowires was prepared according to procedures described in U.S. Patent Application Publication No. 2014/0123808, “NANOWIRE PREPARATION METHODS, COMPOSITIONS, AND ARTICLES,” published May 8, 2014, which is hereby incorporated by reference in its entirety. The silver nanowires in the first set have diameters ranging from 38 nm to 44 nm and lengths ranging from 17 to 25 μm, which are referred to as 40 nm wires.

The second through fourth sets of silver nanowires were prepared according to procedures described in U.S. Patent Application Publication No. 2012/0328469, entitled “NANOWIRE PREPARATION METHODS, COMPOSITIONS, AND ARTICLES,” published Dec. 27, 2012, which is hereby incorporated by reference in its entirety. The silver nanowires in the second set have diameters ranging from 32 nm to 34 nm and lengths ranging from 12 to 15 μm, which are referred to as 33 nm wires.

The third set of silver nanowires has an average diameter of 28 nm and average length of 15 μm, which are referred to as 28 nm wires.

The fourth type of nanowires has average diameter of 23 nm and average length of 12 μm, which are referred to as 23 nm wires.

### Preparation of Silver Nanowire Coated Substrates

Polyvinyl butyral polymer premix solutions were prepared for each polyvinyl butyral resin (BM-5, BH-9Z, B-72, B-76, B30T, B60H, B60HH, and B60T, B75H) by mixing 3 parts by weight of the polyvinyl butyral resin with 19.4 parts by weight of methanol and 77.6 parts by weight of 2-propanol. Each of the polyvinyl butyral premix solutions was filtered through a 5 micron filter prior to use.

Silver nanowire coating dispersions were prepared from different combinations of silver nanowire dispersions prepared from different sets of silver nanowires (40 nm, 33 nm, 28 nm, and 23 nm) and polyvinyl butyral polymer premix solution prepared from different polyvinyl butyral resins.

Each of the silver nanowire coating dispersion solutions were coated with a Mayer rod onto a 7 mil PET substrate and dried at 250° F. for 2 min.

### Evaluation of Silver Nanowire Coated Substrates

The electrical and optical performance of silver nanowire coated substrates were evaluated based on surface conductivity or corresponding surface resistivity (ohms/sq), haze (%), and nanowire distribution uniformity. The conductivity of prepared conductive films was measured with an RCHEK surface conductivity meter, or an Eddy current reader. The percent haze value was measured with a BYK Gardner haze meter.

For each silver nanowire coated substrate, the product of its surface resistivity value and the haze value (R×H) were calculated. A first silver nanowire coated substrate that has a smaller R×H value than a second silver nanowire coated substrate may indicate that the first silver nanowire coated substrate has either lower surface resistivity, lower haze, or both lower surface resistivity and lower haze than the second nanowire coated substrate. Generally, the first silver nanowire coated substrate with a smaller R×H value has more desirable electrical and optical properties than the second silver coated substrate. To evaluate the performance of a binder in which the silver nanowires are embedded, it may be desirable to compare silver nanowire coated substrates prepared from silver nanowires having similar dimensions (e.g. 40 nm, 33 nm, 28 nm, and 23 nm diameter).

The uniformity of nanowire distribution appearance in the silver nanowire coated substrate is based on visual observation of “mottle” or “mottling” effect. Mottles appear as “patches” from the observer's color impression of irregular areas of light variations. In the examples, mottle was evaluated with an intense flash light reflection from a transparent conductive film with a black background underneath the film. The “mottle” appearance of the films was given a rating on a scale of 1 to 5, 1 being perfectly uniform distributed nanowire appearance with no visually detectable mottle, and 5 being the least uniformly distributed nanowire appearance.

### Example 1

The silver nanowires and silver nanowire coated substrates were prepared according to the methods described above. Silver nanowire coating dispersions containing 40 nm silver nanowires were prepared by mixing 3.20 parts by weight of the polyvinyl butyral polymer premix solution, 13.95 parts by weight of 2-propanol, and 1.30 parts by weight of a 1.85 wt % solids dispersion of 40 nm silver nanowires in 2-propanol. The silver nanowire coating dispersion had 0.65 wt % solids. Table 1 shows the R×H and mottle values for silver nanowire coated substrates having 40 nm silver nanowires embedded in different PVB binders.

### Example 2

The silver nanowires and silver nanowire coated substrates were prepared according to the methods described above. Silver nanowire coating dispersions containing 33 nm silver nanowires were prepared by mixing 3.90 parts by weight of the polyvinyl butyral polymer premix solution, 4.05 parts by weight of ethanol, 29.02 parts by weight of a 1.85% solids dispersion of 33 nm silver nanowires in 2-propanol. The silver nanowire coating dispersion had 0.45 wt % solids. Table 2 shows the R×H and mottle values for silver nanowire coated substrates having 33 nm silver nanowires embedded in different PVB binders.

TABLE 1

| | | Molecular | OH | Surface | | | |
|---|---|---|---|---|---|---|---|
| | PVB | Weight | Content | Resistivity | Haze | | Mot- |
| Sample | Binder | (g/mole) | (mol %) | (ohms/sq) | (%) | RxH | tle |
| 1-1 | B60T | 55K | 35.7 | 141 | 1.77 | 250 | 1.0 |
| 1-2 | B60T | 55K | 35.7 | 139 | 1.71 | 238 | 1.0 |
| 1-3 | B60H | 55K | 28.2 | 107 | 1.70 | 182 | 1.0 |
| 1-4 | B60H | 55K | 28.2 | 104 | 1.73 | 180 | 1.0 |

### Example 3

The silver nanowires and silver nanowire coated substrates were prepared according to the methods described above. Silver nanowire coating dispersions containing 28 nm silver nanowires were prepared by mixing 2.77 parts by weight of the polyvinyl butyral polymer premix solution, 3.0 parts by weight of ethanol, 6.92 parts by weight of a 1.85 wt % solids dispersion of 33 nm silver nanowires in 2-propanol. The silver nanowire coating dispersion had 0.45 wt % solids. Table 3 shows the R×H and mottle values for silver nanowire coated substrates having 28 nm silver nanowires embedded in different PVB binders.

### Example 4

The silver nanowires and silver nanowire coated substrates were prepared according to the methods described above, and the silver nanowire coating dispersions were prepared according to Example 3 except that 23 nm silver nanowires were used. Table 4 shows the R×H and mottle values for silver nanowire coated substrates having 23 nm silver nanowires embedded in different PVB binders.

TABLE 2

| | | Molecular | OH | Surface | | | |
|---|---|---|---|---|---|---|---|
| Sample | PVB | Weight | Content | Resistivity | Haze | | Mot- |
| ID# | Binder | (g/mole) | (mol %) | (ohm/sq) | (%) | RxH | tle |
| 2-1 | B-75H | 100K | — | 101 | 1.13 | 114 | 1.5 |
| 2-2 | B-74 | 135K | — | 97 | 1.11 | 108 | 1.0 |
| 2-3 | B-74 | 135K | — | 64 | 1.48 | 95 | 1.3 |
| 2-4 | BH-9Z | 220K | — | 96 | 1.07 | 103 | 1.0 |
| 2-5 | BH-9Z | 220K | — | 68 | 1.50 | 102 | 1.0 |
| 2-6 | B-72 | 200K | — | 60 | 1.36 | 82 | 1.3 |
| 2-7 | BM-5 | 53K | 34.0 | 133 | 1.73 | 230 | 3.0 |
| 2-8 | BM-5 | 53K | 34.0 | 120 | 1.73 | 208 | 2.0 |
| 2-9 | BM-5 | 53K | 34.0 | 102 | 1.72 | 175 | 2.0 |
| 2-10 | B30T | 35K | 35.7 | 240 | 1.76 | 422 | 3.0 |
| 2-11 | B30T | 35K | 35.7 | 243 | 1.73 | 420 | 3.0 |
| 2-12 | B30T | 35K | 35.7 | 149 | 1.71 | 255 | 5.0 |
| 2-13 | B60T | 55K | 35.7 | 171 | 1.77 | 303 | 2.0 |
| 2-14 | B60T | 55K | 35.7 | 90 | 1.81 | 163 | 2.0 |
| 2-15 | B60T | 55K | 35.7 | 142 | 1.74 | 247 | 1.0 |
| 2-16 | B-72 | 200K | 18.5 | 94 | 1.08 | 102 | 1.0 |
| 2-16 | B-72 | 200K | 18.5 | 60 | 1.36 | 82 | 1.3 |
| 2-17 | B60H | 55K | 28.2 | 118 | 1.84 | 217 | 2.0 |
| 2-18 | B60H | 55K | 28.2 | 118 | 1.80 | 212 | 3.0 |
| 2-19 | B60H | 55K | 28.2 | 94 | 1.73 | 163 | 2.0 |
| 2-20 | B60HH | 55K | 20.9 | 74 | 1.93 | 143 | 3.0 |
| 2-21 | B60HH | 55K | 20.9 | 69 | 1.79 | 124 | 2.0 |

TABLE 3

| | | Molecular | OH | Surface | | | |
|---|---|---|---|---|---|---|---|
| Sample | PVB | Weight | Content | Resistivity | Haze | | Mot- |
| ID# | Binder | (g/mole) | (mol %) | (ohm/sq) | (%) | RxH | tle |
| 3-1 | BH-9Z | 220K | 34. | 64 | 1.02 | 65 | 1.0 |
| 3-2 | B-72 | 200K | 18.5 | 54 | 1.06 | 57 | 1.2 |

TABLE 4

| | | Molecular | OH | Surface | | | |
|---|---|---|---|---|---|---|---|
| | PVB | Weight | Content | Resistivity | Haze | | Mot- |
| Sample | Binder | (g/mole) | (mol %) | (ohm/sq) | (%) | RxH | tle |
| 4-1 | B-72 | 200K | 18.5 | 84 | 0.77 | 65 | 1.0 |
| 4-2 | B-72 | 200K | 18.5 | 50 | 0.98 | 49 | 1.0 |
| 4-3 | BH-9Z | 220K | 34.0 | 84 | 0.79 | 66 | 1.0 |
| 4-4 | BH-9Z | 220K | 34.0 | 64 | 0.93 | 60 | 1.0 |

### Example 5

The silver nanowires and silver nanowire coated substrates were prepared according to the methods described above. Silver nanowire coating dispersions containing 23 nm silver nanowires and dispersion agent (NUOSPERSE FA196, Elementis) were prepared by mixing 10 parts by weight of methanol, 4 parts by weight of ethyl lactate, 35 parts by weight of a 0.50 wt % solids dispersion of 23 nm silver nanowires in 2-propanol, 0.0007 parts by weight of NUOSPERSE FA196 (Elementis), and a varying amount of the 3 wt % polyvinyl butyral polymer premix solution as showed in Table 5. The silver nanowire coating dispersion had % solids as showed in Table 5. Table 5 shows the R×H and mottle values for silver nanowire coated substrates having 23 nm silver nanowires embedded in different PVB binders with dispersion agent NUOSPERSE FA196.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the attached claims, and all changes that come within the meaning and range of equivalents thereof are intended to be embraced therein.

TABLE 5

| | | | | 3 wt % PVB Premix | | | | | |
|---|---|---|---|---|---|---|---|---|---|
| | | Molecular | OH | Solution Loading in | | Surface | | | |
| Sample | PVB | Weight | Content | Coating Dispersion | Solids | Resistivity | Haze | | |
| ID# | Binder | (g/mol) | (mol %) | (wt %) | (wt %) | (ohm/sq) | (%) | RxH | Mottle |
| 5-1 | B-72 | 200K | 18.5 | 5.8 | 0.35 | 55 | 0.85 | 28 | 1.0 |
| 5-2 | B-72 | 200K | 18.5 | 17.5 | 0.70 | 58 | 0.94 | 34 | 1.0 |
| 5-3 | BH-9Z | 220K | 34.0 | 5.8 | 0.35 | 51 | 1.00 | 33 | 1.0 |
| 5-4 | BH-9Z | 220K | 34.0 | 17.5 | 0.70 | 58 | 0.89 | 31 | 1.0 |

What is claimed:

1. A conductive article comprising:
conductive structures dispersed within at least one binder,
wherein the at least one binder comprises vinyl butyral repeat units and vinyl alcohol repeat units.

2. The conductive article of claim 1, wherein the conductive structures comprise metallic structures.

3. The conductive article of claim 1, wherein the conductive structures comprise metallic nanostructures.

4. The conductive article of claim 1, wherein the conductive structures comprise metallic nanowires.

5. The conductive article of claim 1, wherein the conductive structures comprise silver nanowires.
